(19) United States
(12) Patent Application Publication
(10) Pub. No.: US 2016/0009075 A1
(43) Pub. Date: Jan. 14, 2016

(54) INTAGLIO PRINTING

(71) Applicant: SICPA HOLDING SA, Prilly (CH)

(72) Inventors: Olivier Lefebvre, Montagny-pres-Yverdon (CH); Pierre Degott, Crissier (CH); Patrick Magnin, Maxilly-sur-Leman (FR); Christophe Schaller, Ollon (CH)

(73) Assignee: SICPA HOLDING SA, Prilly (CH)

(21) Appl. No.: 14/771,603

(22) PCT Filed: Dec. 13, 2013
(86) PCT No.: PCT/EP2013/076541

§ 371 Date: Aug. 31, 2015

(30) Foreign Application Priority Data
Mar. 1, 2013 (EP) 13157391.7

(51) Int. Cl. B41F 11/02; B42D 25/36; B41F 9/00

(52) U.S. Cl. CPC B41F 11/02; B41F 9/00; B42D 25/36

(57) ABSTRACT

For improving the intaglio printing of inks comprising large particles such as optically variable pigment particles and/or optically variable magnetic or magnetizable pigment particles, the invention proposes a process for intaglio printing a feature or pattern comprising the steps of (i) inking one or more chablon cylinders with one or more low viscosity inks, and comprising particles having a size (d50) up to about 90 microns with one or more screen cylinders comprising urging means, the one or more screen cylinders being connected by means of a connecting duct to an intaglio ink reservoir, (ii) transferring the one or more inks from the one or more chablon cylinders to a plate cylinder carrying one or more an intaglio engraved plates, (iii) transferring one or more inks ink from the plate cylinder carrying one or more an intaglio engraved plates to a substrate, and (iv) hardening or curing the one or more inks.

### FIELD OF THE INVENTION

The present invention relates to the field of security documents and their protection against counterfeit and illegal reproduction. In particular the present invention relates to the field of intaglio printing processes for the printing of security documents.

### BACKGROUND OF THE INVENTION

With the constantly improving quality of color photocopies and printings and in an attempt to protect security documents against counterfeiting, falsifying or illegal reproduction, it has been the conventional practice to incorporate various security means in these documents. Such security documents can be banknotes, value documents or cards, transportation tickets or cards, tax banderols, and product labels that have no reproduceable effects. Typical examples of security means include security threads, windows, fibers, planchettes, foils, decals, holograms, watermarks, security inks comprising optically variable pigments, magnetic or magnetizable thin-film interference pigments, interference-coated particles, thermochromic pigments, photochromic pigments, luminescent, infrared-absorbing, ultraviolet-absorbing or magnetic compounds. In addition to those security features, security documents often carry a tactilely-detectable or feelable surface profile pattern which may be generated by means of printing.

Intaglio printing is used in the field of security documents, in particular banknotes, and delivers the most consistent and high quality printing of fine lines. Moreover, intaglio printing confers the well-known and recognizable relief features, in particular the unmistakable touch feeling, to a printed document. Intaglio printing processes (also referred in the art as engraved steel die or copper plate printing processes) refer to a printing method used in the field of printing security documents, in particular for banknotes printing.

Intaglio inks are known to be very specific and must satisfy the following and other requirements: rheological properties (intaglio inks are pasty compositions having a high viscosity typically in a range between 3 Pa·s and 80 Pa·s at 40° C. and 1000 s⁻¹), wipeability and detergeability.

Inks comprising large particles, in particular optically variable inks, are known in the field of security printing and are used in coatings or layers so as to provide an optically variable element on a security document. Optically variable elements (also referred in the art as colorshifting elements or goniochromatic elements) exhibit a viewing-angle or incidence-angle dependent color, and are used to protect banknotes and other security documents against counterfeiting and/or illegal reproduction by commonly available office equipment for color scanning, printing and copying. For example, layers made of an optically variable ink comprising optically variable pigment particles exhibit a colorshift upon variation of the viewing angle (e.g. from a viewing angle of about 90° with respect to the plane of the layer to a viewing angle of about 22.5° with respect to the plane of the layer) from a color impression CI1 (e.g. green) to a color impression CI2 (blue). The colorshifting property of a security element is considered to be an easy-to-detect overt security feature for the public. Advantageously, any one is able to easily detect, recognize and/or discriminate documents or article comprising said security element from their possible counterfeits with the unaided human senses, e.g. such features may be visible and/or detectable while still being difficult to produce and/or to copy. Moreover, the colorshifting property of the coating layer may be used as an authentication tool for the recognition of security documents by a machine.

While high viscosity inks comprising large particles such as for example optically variable pigment particles may be used for intaglio printing processes, such high viscosities may cause ink transfer issues during the intaglio printing process. Moreover, features or patterns printed with inks comprising optically variable pigment particles may suffer from poor optical characteristics due to a not optimized orientation of pigment particles.

During conventional intaglio printing processes, a rotating engraved steel cylinder, or a rotating steel cylinder carrying an engraved plate, with a pattern or image to be printed is supplied with ink by one or by a plurality of selective inking cylinder(s) (or chablon cylinder(s)), each selective inking cylinder being inked in at least one corresponding color to form multi-shade features.

Subsequently to the inking step, wiping off any ink excess present on the surface of the intaglio printing plate is performed. Then, the inked intaglio plate is brought into contact with a substrate in sheet form or web form, and the ink is transferred under pressure from the engravings of the intaglio printing plate onto the substrate to be printed, forming a thick relief printing pattern on the substrate.

The intaglio plate wiping step may be carried out by using a paper or a tissue wiping system (“calico”) or a polymeric roll wiping system (“wiping cylinder”). Because of the amount of waste material, for industrial intaglio printing, the wiping step is increasingly carried out with a rotating polymeric wiping cylinder; wiping off with paper or tissue is practically no longer used on an industrial printing press. The wiping cylinder is in turn cleaned in a bath comprising a solvent or an aqueous solution; or the wiping cylinder is cleaned with a solution spray; optionally brushes or Scotch-Brite™ material may also additionally be used. Due to the growing environmental concerns and regulations on volatile organic compounds, cleaning of the wiping cylinder with solvent is practically no longer used. Typically the washing solution used to clean the wiping cylinder is a basic aqueous solution comprising caustic soda and a surfactant such as e.g. sulfated castor oil (SCO).

### SUMMARY OF THE INVENTION

The inventors have recognized that the intaglio printing of inks comprising large particles can be improved if the intaglio processes would use low viscosity inks comprising large particles, in particular optically variable pigment particles and/or optically variable magnetic or magnetizable pigment particles.

Accordingly, the present invention overcomes the deficiencies of the prior art by the provision of a process for intaglio printing a feature or pattern comprising the steps of:

i) inking one or more chablon cylinders with one or more inks having a viscosity falling within the range between about 0.1 Pa·s and about 10 Pa·s at 25° C. and at a shear rate of 1000 s⁻¹, preferably between about 0.1 Pa·s and about 5 Pa·s at 25° C. and 1000 s⁻¹, and within the range between about 0.1 Pa·s and about 30 Pa·s at 25° C. and at a shear rate of 100 s⁻¹, preferably between about 0.1 and about 20 Pa·s at 25° C. and at a shear rate of 100 s⁻¹, and comprising particles having a size (d50) up to about 90 microns with the use of one or more screen cylinders comprising urging means such as a squeegee, the one or more screen cylinders being connected by means of a connecting duct to an intaglio ink reservoir,
ii) transferring the one or more inks from the one or more chablon cylinders to a plate cylinder carrying one or more intaglio engraved plates,
iii) transferring the one or more inks from the plate cylinder carrying one or more intaglio engraved plates one or more to a substrate, and
iv) hardening or curing the one or more inks.

There are disclosed and claimed herein security features or patterns printed by the process described herein and security documents comprising one or more of said security features or patterns as well as uses of said security features or patterns for the protection of a security document against fraud or illegal reproduction.

There are disclosed and claimed herein printing assemblies comprising:

a) one or more screen cylinders comprising urging means such as a squeegee, each screen cylinder being connected by means of a connecting duct to an intaglio ink reservoir,
b) one or more chablon cylinders, and
c) a plate cylinder carrying one or more intaglio engraved plates.

There are disclosed and claimed herein uses of the one or more inks described herein in combination with the printing assembly described herein for printing a feature or pattern, in particular a security feature or security pattern, by an intaglio printing process.

The processes described and claimed therein advantageously provide high quality patterns or features, in particular security patterns or security features, in an improved, predictable and controlled way, said processes using a intaglio printing process so as to take advantages of this printing technique, including recognizable relief effect (i.e. tactile effect) and anti-soiling characteristics.

### BRIEF DESCRIPTION OF DRAWINGS

FIG. 1 shows a side view of a plate cylinder carrying three intaglio engraved plates and forming a nip with the chablon cylinders of three inking trains, with a counter-pressure cylinder, and with a wiping cylinder;

FIG. 2 shows a side view of the plate cylinder carrying three intaglio engraved plates; in this embodiment, the plate cylinder forms a nip with a collecting cylinder carrying two blankets, with a counter-pressure cylinder, and with a wiping cylinder; the collecting cylinder, in turn, forming nips with the chablon cylinders of three inking trains; and

FIG. 3 shows a perspective front view of the cylinder surface of a plate cylinder forming a nip with the chablon cylinder of an inking train, the diameters of the cylinders shown not being representative of the actual diameters in an intaglio imprinting press.

### DETAILED DESCRIPTION

### Definitions

The following definitions are to be used to interpret the meaning of the terms discussed in the description and recited in the claims.

As used herein, the article “a” indicates one as well as more than one and does not necessarily limit its referent noun to the singular.

As used herein, the term “about” in conjunction with an amount or value means that the amount or value in question may be the specific value designated or some other value in its neighborhood. Generally, the term “about” denoting a certain value is intended to denote a range within ±5% of the value. As one example, the phrase “about 100” denotes a range of 100±5, i.e. the range from 95 to 105. Preferably, the range denoted by the term “about” denotes a range within ±3% of the value, more preferably ±1%. Generally, when the term “about” is used, it can be expected that similar results or effects according to the invention can be obtained within a range of ±5% of the indicated value.

The terms “ink” refers to any composition which is capable of forming a coating on a solid substrate and which can be applied by a printing method.

As used herein, the term “and/or” means that either all or only one of the elements of said group may be present. For example, “A and/or B” shall mean “only A, or only B, or both A and B”. In the case of “only A”, the term also covers the possibility that B is absent, i.e. “only A, but not B”. In case of “only B”, the term also covers the possibility that A is absent, i.e. “only B, but not A”.

As used herein, the term “at least” is meant to define one or more than one, for example one or two or three.

The term “comprising” as used herein is intended to be non-exclusive and open-ended. Thus, for instance a composition comprising a compound A may include other compounds besides A.

The terms “composition” refers to any liquid or slurry which is capable of forming a layer or a coating on a solid substrate and which can be applied preferentially but not exclusively by a printing method. As used herein, the term “intaglio ink” refers to an ink suitable for the intaglio printing process, and the term “intaglio ink composition” refers to an ink composition suitable for the intaglio printing process.

The term “security document” refers to a document which is usually protected against counterfeit or fraud by at least one security feature. Examples of security documents include without limitation value documents and value commercial goods. Typical example of value documents include without limitation banknotes, deeds, tickets, checks, vouchers, fiscal stamps and tax labels, agreements and the like, identity documents such as passports, identity cards, visas, bank cards, credit cards, transactions cards, access documents, entrance tickets and the like.

The term “inking train” refers to an assembly comprising a ink reservoir (ink fountain), a ink conducting duct, a screen cylinder, a chablon cylinder and optionally one or more ink transfer cylinders in-between the screen cylinder and the chablon cylinder.

Viscosity values for the invention described and claimed herein were obtained with a stress-controlled rheometer AR1500 from TA Instruments (159 Lukens Drive, New Castle, Del. 19720, USA). A cone and plate geometry of 20 mm diameter, 0.5° cone angle and 21 microns truncation of a titanium cone was used, and samples were run at the temperature of 25° C.±0.1° C. and at a given shear rate. Suitable inks for the present invention have a viscosity falling within the range between about 0.1 Pa·s and about 10 Pa·s, preferably between about 0.1 Pa·s and about 5 Pa·s, at 25° C. and at a shear rate of 1000 s⁻¹, and within the range between about 0.1 Pa·s and about 30 Pa·s, preferably between about 0.1 Pa·s and about 20 Pa·s, at 25° C. and at a shear rate of 100 s⁻¹. For comparative purpose, standard pasty intaglio inks have a viscosity between about 15 Pa·s and about 100 Pa·s at 25° C. and at a shear rate of 1000 s⁻¹ and between about 50 Pa·s and about 150 Pa·s at 25° C. and at a shear rate 100 s⁻¹.

Particle sizes as stated herein are stated for three-dimensional particles. The three-dimensional extension of these particles can consequently be expressed in the three Cartesian dimensions length, width, and height. To these particles, a two-dimensional aspect ratio is applied by treating one of the three dimensions as negligible. The aspect ratio for the remaining two dimensions of the particles used in the present invention is between about 1 and about 100, preferably between about 1 and 80. The stated sizes (d50) are stated for the larger of the two dimensions having this aspect ratio. The particle size is expressed by the d50 value which corresponds to a particle size below which 50 wt-% of the particles lie, wherein the d50 value is determined by means of laser diffraction with a Malvern Mastersizer Micro-P.

The present invention provides processes for intaglio printing a feature or pattern, preferably a security feature or security pattern, as well as features or patterns, preferably security features or security patterns, obtained therefrom. The process for intaglio printing a feature or pattern, preferably a security feature or security pattern, combines the use of one or more inks having a viscosity falling within the range between about 0.1 Pa·s and about 10 Pa·s at 25° C. and at a shear rate of 1000 s⁻¹, preferably between about 0.1 Pa·s and about 5 Pa·s at 25° C. and 1000 s⁻¹, and within the range between about 0.1 Pa·s and about 30 Pa·s at 25° C. and at a shear rate of 100 s⁻¹, preferably between about 0.1 Pa·s and about 20 Pa·s at 25° C. and at a shear rate of 100 s⁻¹, and comprising particles, preferably optically variable pigment particles, having a size (d50) up to about 90 microns, preferably between about 2 microns to about 90 microns, more preferably between about 3 microns to about 60 microns, with a) conventional intaglio equipments including one or more chablon cylinders (also referred to as selective inking cylinders) and a plate cylinder carrying one or more intaglio engraved plates and b) one or more screen cylinders comprising urging means such as a squeegee, the one or more screen cylinders being connected by means of a connecting duct to an ink reservoir (also referred in the art as an ink fountain). Each of the one or more inks described herein is present on an independent inking train (i.e. the assembly comprising an ink reservoir (ink fountain), a conducting duct, a screen cylinder, a chablon cylinder).

Suitable screen cylinders for the present invention are similar to screen cylinders used for conventional silkscreen printing processes. Screen printing is further described for example in The Printing ink manual, R. H. Leach and R. J. Pierce, Springer Edition, 5^{th} Edition, pages 58-62 and in Printing Technology, J. M. Adams and P. A. Dolin, Delmar Thomson Learning, 5^{th} Edition, pages 293-328.

During the printing process described herein, the one or more inks having a viscosity falling within the range between about 0.1 Pa·s and about 10 Pa·s at 25° C. and at a shear rate of 1000 s⁻¹, preferably between about 0.1 Pa·s and about 5 Pa·s at 25° C. and 1000 s⁻¹, and within the range between about 0.1 Pa·s and about 30 Pa·s at 25° C. and at a shear rate of 100 s⁻¹, preferably between about 0.1 Pa·s and about 20 Pa·s at 25° C. and at a shear rate of 100 s⁻¹, and comprising particles having a size (d50) up to about 90 microns, preferably between about 2 microns to about 90 microns, more preferably between about 3 microns to about 60 microns, preferably optically variable pigment particles, are transferred to a surface through a fine fabric mesh of silk, mono- or multi-filaments made of synthetic fibers such as for example polyamides or polyesters or metal threads stretched tightly on a frame made for example of wood or a metal (e.g. aluminum or stainless steel). Alternatively, the screen-printing mesh may be a chemically etched, a laser-etched, or a galvanically formed porous metal foil, e.g. a stainless steel foil. The apertures, or pores, of the mesh are blocked-up in the non-image areas and left open in the image area, the image carrier being called the screen. Each screen cylinder is linked, by means of a connecting duct, to an intaglio ink reservoir. The ink is continuously pumped in the inner volume of the cylinder, i.e. on the interior surface of the cylinder, by means of a duct coupled to the ink reservoir. By urging the ink with suitable means, for instance by applying a squeegee, the ink is forced through the open pores of the stencil.

The screen-printing mesh is chosen such as to have the appropriate mesh size so as to allow for the safe passing of the large particles comprised in the one or more inks described herein through the screen. Therefore, the screen-printing mesh preferably has a free mesh aperture of about twice or three time the size of the large particles. The shape of the pores or apertures can be round, circular, square, polygonal (e.g. hexagonal), with the following mesh sizes being provided as examples:

| Mesh Size | Aperture [microns] |
|---|---|
| 137 lines/inch | 110 |
| 165 lines/inch | 71 |
| 195 lines/inch | 68 |
| 230 lines/inch | 55 |

Such meshes are commercially available from, for instance, KBA-NotaSys SA (under the trade name NotaMesh®) and Stork Prints B.V. (under the trade names SecuPlate® or RotaMesh®).

The open apertures, or pores, correspond to the areas of the one or more chablon cylinders to be inked, while the closed apertures, or pores, correspond to the one or more chablon cylinders areas to be left ink-free. The external surface of each screen cylinder is held in contact with the surface of a chablon cylinder and the ink is transferred to the one or more chablon cylinders. Subsequently, the ink is transferred from the one or more chablon cylinders to the plate cylinder carrying one or more intaglio engraved plates.

Chablon cylinders (also referred to as selective inking cylinders) are known to the persons skilled in the art. The term “chablon cylinder” refers to a cylinder having a polymeric material or rubber surface. Reference is made to e.g. EP 1 842 665 A1. Preferably, the one or more chablon cylinders are made of a material selected from the group consisting of rubbers, polyurethane rubbers (PUR rubber), silicone rubbers, polyvinyl chlorides (PVC), polyfluoroethylenes, ethylene propylene diene monomers (EPDM, ethylene propylene diene monomer rubber) and mixtures thereof. In order to increase the lifetime of the chablon cylinders, the polymeric material is selected according to the type of ink to be used. In particular, chablon cylinders used in combination with oxidatively drying intaglio inks are preferably made of PUR rubber. Because monomeric and/or oligomeric components of radiation curable inks, preferably UV-Vis curable inks, tend to cause swelling and/or stickiness of PUR rubber, chablon cylinders used in combination with radiation curable inks, preferably UV-Vis curable inks, are preferably made of EPDM material. Examples of material suitable for the present invention are disclosed e.g. in Rubber rollers in today's printing processes, T. L. Traeger, Rubber World, Oct. 1, 1999; Böttcher Systems in bottcher.com); reference is additionally made to WO 2009/013169 A1 for the inks.

Each chablon is inked by its associated inking device and thus transfers one colored ink to the associated plate cylinder or to the collecting cylinder. Therefore, chablon cylinders are also referred in the literature as selective inking cylinders.

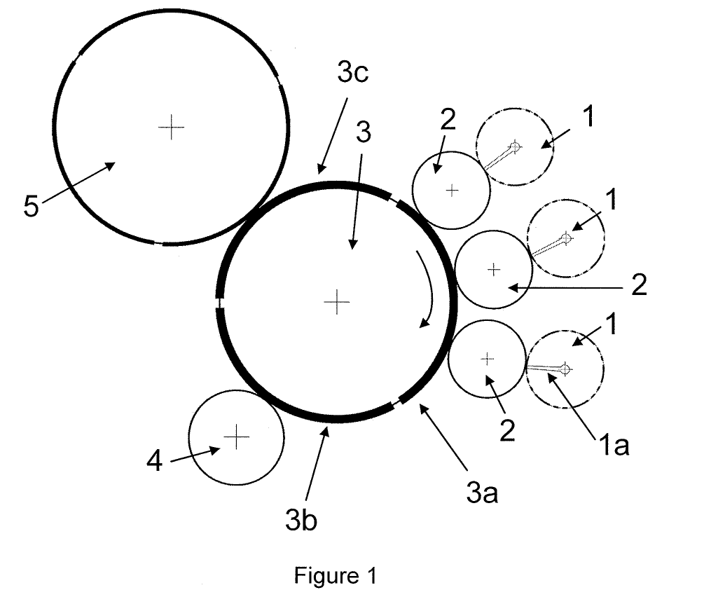

The Figures show exemplary successions of cylinders for inking trains in an intaglio printing press. FIG. 1 shows a side view of a succession. In the center of the succession, 3 designates a plate cylinder. This plate cylinder carries three intaglio engraved plates, 3a, 3b and 3c. The direction of rotation of the plate cylinder is indicated by an arrow.

Three inking trains are arranged in succession around the outer circumference of the plate cylinder. Each inking train comprises a screen cylinder 1 having a squeegee 1a acting against its inside cylinder surface, and a chablon cylinder 2. Each screen cylinder 1 is further connected to an ink reservoir (not shown). The screen cylinders shown in the Figures are similar to screen cylinders used for conventional silkscreen printing processes.

In the shown arrangement, each chablon cylinder 2 forms a nip with the intaglio engraved plates 3a, 3b and 3c of the plate cylinder 3. Further downstream around the circumference of the plate cylinder 3, when viewed in the direction of its rotation, FIG. 1 shows a wiping cylinder 4 and counter-pressure cylinder 5. Both are arranged so that they form a nip with the intaglio engraved plates 3a, 3b and 3c on the plate cylinder 3. Each intaglio engraved plate thus passes a first nip with a first inking train, a second nip with a second inking train, a third nip with a third inking train, a nip with the wiping cylinder and, finally, a nip with the counter-pressure cylinder 5. This design per se is known to the skilled person so that a further description is not necessary.

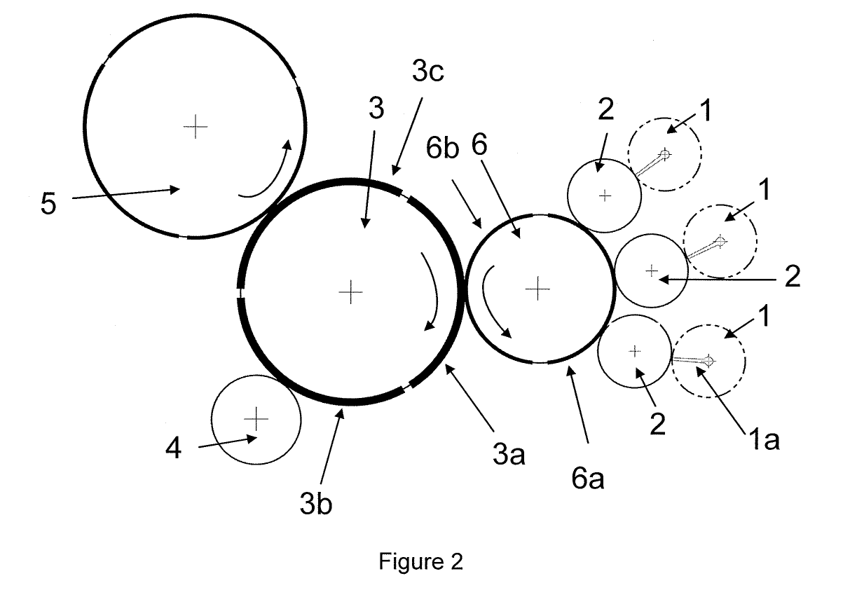

Although FIG. 1, and also FIG. 2 described below, show each inking train to comprise a screen cylinder, this is not necessarily the case for practicing the invention. The invention proposes the use of a particular ink for an intaglio printing process, the ink having a dynamic viscosity lower than the inks conventionally used in intaglio printing processes. A screen cylinder instead of, for instance, a selective inking cylinder as known in the art, will thus only be necessary in a particular inking train if the ink to be processed in that inking trains is as proposed by the invention, which is not necessarily the case for all inking trains in an intaglio printing process. It is thus within the scope of invention to supply low viscosity ink by means of a screen cylinder only in one of the inking trains employed in the process. Whilst this one inking train will then utilize a screen cylinder, the others will not necessarily do so. It is also within the scope of the invention to supply low viscosity ink by means of a screen cylinder in some of the inking trains, or in all of the inking trains employed. Similarly, although three inking trains are depicted, it is also within the scope of the invention to employ more than three, only two, or only a single inking train.

FIG. 2 shows a variation of the ink supply to the plate cylinder 3. In the inking trains shown in FIG. 2, the screen cylinders 1 and the chablon cylinders 2, as well as the connection to the ink reservoir (not shown), are embodied as described with respect to FIG. 1. However, in the variation of FIG. 2, the chablon cylinders 2 form a nip with a collecting cylinder 6. The collecting cylinder 6 is shown to carry two blankets 6a and 6b. These combine well with the three intaglio engraved plates 3a, 3b and 3c on the plate cylinder 3, as is conventionally known. However, different combinations are also within the scope of the invention, for instance a collecting cylinder 6 carrying three blankets in conjunction with three intaglio engraved plates on the plate cylinder, a collecting cylinder carrying four blankets in conjunction with a plate cylinder carrying three intaglio engraved plates, or even other combinations.

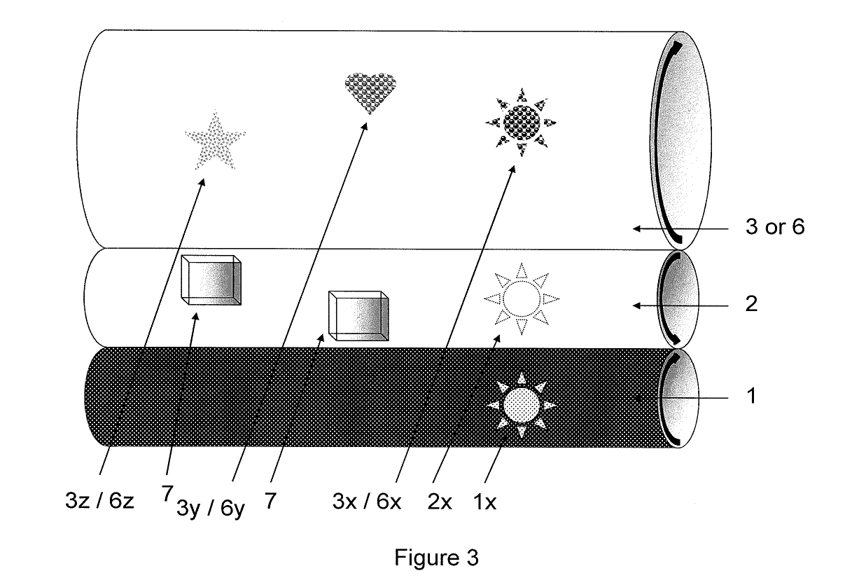

FIG. 3 shows a perspective front view onto the cylinder surface of a succession of a screen cylinder 1, a chablon cylinder 2 and a cylinder which may either be a plate cylinder 3 or a collecting cylinder 6. Only one inking train is apparent from FIG. 3. Further inking trains have been omitted from the drawing only so as to simplify the illustration. The urging means, for instance a squeegee, on the inside of the screen cylinder has likewise been omitted for simplification.

Presently, in the embodiment shown in FIG. 3, at least two further inking trains were omitted, as may be gathered from the indicia 3x/6x, 3y/6y, 3z/6z that are evident on the cylinder surface of the plate cylinder 3 or collecting cylinder 6. These indicia are a sun 3x/6x, a star 3y/6y and a heart 3z/6z. They are shown to all be located on the same intaglio engraved plate if the ink is transferred to a plate cylinder 3, or on the same blanket if it is transferred to a collecting cylinder 6. However, it is also within the scope of the invention to provide a varying number of indicia on the same and/or different intaglio engraved plates and/or blankets.

FIG. 3 illustrates the transfer of ink through open pores in the screen cylinder 1, initially to chablon cylinder 2 and then to either a plate cylinder 3 or a collecting cylinder 6. The direction of rotation of these three cylinders is indicated by arrows. At 1× in FIG. 3, pores in the mesh of the screen which in conjunction form indicia, for example the depicted sun, are open so as to permit ink with the viscosity specified in the appended claims and comprising particles having the size specified in the appended claims to pass therethrough. On chablon cylinder 2, reference sign 2x indicates, in phantom lines, area on chablon cylinder 2 to be inked upon continued rotation of the three cylinders of FIG. 3. When the open pores on the screen cylinder 1 and area 2x on chablon cylinder 2 approach one another, the action of the squeegee or some other suitable urging means on the inside of the screen cylinder will urge the ink through the open pores of the screen and, upon contact of areas 1x and 2x in the nip between screen cylinder 1 and chablon cylinder 2, onto the surface of the chablon cylinder 2 (at the location corresponding to 2x). As a result, the same indicia, here again the sun as an example, will be formed on chablon cylinder 2. Further rotation of the cylinders will then cause the sun to be transferred as an ink indicia onto the plate cylinder 3 or collecting cylinder 6. For the sake of illustration, FIG. 3 shows indicia 3x/6x on the cylinder 3/6, which have been transferred during a previous contact between area 2x and the surface of the cylinder 3/6.

So as to permit the printing of several indicia by means of several inking trains, in the depicted embodiment two further indicia, by means of further inking trains upstream of cylinders 1 and 2 shown in FIG. 3 (not shown), chablon cylinder 2 as shown in FIG. 3 contains recessed portions 7. Because of the recessed portions, the surface of chablon cylinder 2 at that location will not come into contact with the surface area on plate cylinder 3 or collecting cylinder 6 already bearing ink indicia, such as the star 3y/6y or heart 3z/6z. In this manner, back contamination, that is to say contamination from the plate cylinder 3 or collecting cylinder 6 via the surface of chablon cylinder 2 back to the screen, and the resulting mixture of inks from different inking trains can be prevented.

The plate cylinder 3 has a bigger diameter than the screen cylinders 1 and the chablon cylinders 2. Typical ratios between the diameter of the plate cylinder and the screen and chablon cylinders result from the plate cylinder comprising the one or more intaglio engraved plates having a specific length in the printing direction (indicated by the arrow). The circumference of each screen cylinder will typically be similar to the length of its associated intaglio engraved plate.

The plate cylinder 3 forms a nip with the counter-pressure cylinder 5 which has a diameter similar to the diameter of the plate cylinder 3. The plate cylinder 3 also forms a nip with a wiping cylinder 4. As viewed in the printing direction, the wiping cylinder is advantageously located downstream of the last inking train and upstream of the counter-pressure cylinder 5, with a sufficient circumferential gap to permit passage of the substrate to be printed.

When it is desired to apply a single ink to form a feature or pattern on a substrate, the one or more chablon cylinders described herein may comprise a smooth surface devoid of any raised or recessed areas or portions. Even though this surface has the curvature of the cylinder, so that it is three-dimensional, this type of surface is designated with “planar surface” in this text. Alternatively and when it is desired to apply more than one ink, to form a feature or pattern on a substrate, the one or more chablon cylinders described herein may comprise recessed areas or portions preferably in dimensions corresponding to the form of indicia, even if the one or more chablon cylinders are then practically used to apply a single ink. Such recessed areas or portions can thus be used to apply one or more inks.

According to one embodiment, the one or more chablon cylinders described herein comprise a plurality of recessed areas on their surface, preferably a plurality of recessed areas in the form of indicia, said recessed areas relating to the engravings of the intaglio plate to be inked by the others inking trains of the intaglio printing press. Thus, contamination of an inking train by inks delivered by the other inking trains may be avoided. The recessed areas can be generated by engraving or otherwise machining the one or more chablon cylinders, of even by means of exposing or applying ink repelling coating or anti-marking nets at these areas.

As employed in the present invention, the chablon cylinders having a plurality of recessed areas and the chablon cylinders having a planar surface are useful to prevent premature wearing off of the screen cylinder and/or of the chablon cylinders. Premature wearing off of the screen cylinder and/or of the chablon cylinders may arise from the strains produced by the application of the squeegee on the screen cylinder in contact with the chablon cylinder.

When chablon cylinders having a planar surface are used with the screen cylinder, the complete surface of the chablon cylinder acts as a counter-pressure to the squeegee; consequently, the screen will not be subjected to deforming strains. When chablon cylinders comprising recessed areas are used with the screen cylinder, counter-pressure is carried out by the non-recessed parts of the chablon cylinder, while no counter-pressure occurs in the recessed areas; consequently, the screen is only slightly pushed down into the recessed areas without any consequence for the screen integrity.

According to one embodiment of the present invention, the chablon cylinders may advantageously be thermo-regulated so as to ensure a stable operating temperature.

The one or more screen cylinders, the one or more chablon cylinders and the plate cylinder carrying one or more intaglio engraved plates are positioned such as to transfer the intaglio ink selectively to the intaglio plate imprint region. The areas of the screen cylinder comprising the open pores correspond to the areas of the chablon cylinder to be inked. The inked areas of the chablon cylinder, in turn, face the intaglio plate in regions comprising the engravings; thus the intaglio ink is transferred from the chablon cylinders into the furrow elements of the engravings. For a description of furrow elements reference is made to WO 2005/090090 A1 entitled Intaglio Printing Plate. By using the screen cylinders coupled with the chablon cylinders, the engravings of the intaglio plate are inked selectively. Thus, the amount of intaglio ink transferred to the non-engraved regions of the intaglio plate is strongly reduced, i.e. the non-engraved parts of the intaglio plate remain substantially ink-free. Thereby, the inking process of the present invention strongly reduces the amount of intaglio ink wiped off and discarded during the wiping process of the intaglio plate.

The process for intaglio printing a feature or pattern, preferably a security feature or security pattern, described herein may further use a collecting cylinder (also referred to as an Orlov or Orlof cylinder) in combination with the one or more chablon cylinders, with the plate cylinder carrying one or more intaglio engraved plates and with the one or more screen cylinders described herein. The process described herein may then further comprise a step of transferring the one or more inks from the one or more chablon cylinders to the surface of a collecting cylinder, also called the Orlov cylinder carrying one or more “blankets”, said step being prior to the transfer of the one or more inks to the plate cylinder carrying one or more intaglio engraved plates. During such a process, the one or more inks having a viscosity falling within the range between about 0.1 Pa·s and about 10 Pa·s at 25° C. and at a shear rate of 1000 s¹, preferably between about 0.1 Pa·s and about 5 Pa·s at 25° C. and 1000 s⁻¹, and within the range between about 0.1 Pa·s and about 30 Pa·s at 25° C. and at a shear rate of 100 s⁻¹, preferably between about 0.1 Pa·s and about 20 Pa·s at 25° C. and at a shear rate of 100 s⁻¹, and comprising particles, preferably optically variable pigment particles, having a size (d50) up to about 90 microns, preferably between about 2 microns to about 90 microns, more preferably between about 3 microns to about 60 microns, are transferred from an intaglio ink reservoir via the one or more screen cylinders to the one or more chablon cylinders; subsequently, the one or more inks are transferred from the one or more chablon cylinders to the collecting cylinder, which, in turn, transfers the ink to the plate cylinder carrying the one or more intaglio engraved plates. Finally the one or more inks are printed from the plate cylinder carrying the one or more intaglio engraved plates onto the substrate to form the printed intaglio feature or pattern. The process of inking by means of a collecting cylinder is called indirect inking process, or Orlov process. The indirect intaglio inking process brings in particular two benefits: reduced ink consumption and new design possibilities; in particular, the design possibilities benefit from the extremely precise inking and color splits. In the Orlov process, the one or more blankets carried by the collecting cylinder can be made of a woven fabric material coated with rubber. Examples of blanket material comprise e.g. polyurethane rubber (PUR rubber), acrylonitrile butadiene rubber (NBR); examples are given e.g. in U.S. Pat. No. 5,264,289, WO 2007/062271 A1 and JP 2011/173376-7 A. In order to increase the lifetime of the blanket, the fabric material of the blanket is selected according to the ink composition to be used, for instance depending on whether oxidatively drying inks or UV-Vis curable inks are to be used. Nevertheless, some materials, e.g. acrylonitrile butadiene rubber (NBR), silicone rubber, show excellent resistance to both oxidatively drying inks and UV-Vis curable inks and are thus used preferably (see e.g. U.S. Pat. No. 5,264,289).

Collecting cylinders (i.e. Orlov cylinders) are known in the art. Reference is made to e.g. EP 2 065 187 B1, US 2008/0271620, as well as the references cited therein. Collecting cylinders are used with different printing technologies such as e.g. offset and intaglio. In the Orlov method, chablon cylinders are inked by the inking devices with different colors. The colors are then transferred from the chablon cylinders onto a common collecting cylinder, i.e. the Orlov cylinder. The collecting cylinder, which accordingly carries on its surface the inks in the different colors, is used to ink the surface of the plate cylinder. Accordingly, a single printing plate is inked with inks of different color which have been previously collected onto a common ink-collecting surface, thereby allowing a perfect register between the different colors. In the invention, the collecting cylinder, if employed, may have a diameter smaller similar or bigger than the diameter of the plate cylinder.

Subsequently, the one or more inks described herein are transferred from the one or more chablon cylinders described herein or from the collecting cylinder described herein into the engravings of the plate cylinder one or more intaglio engraved plates, said one or more intaglio engraved plates being standard ones. Suitable intaglio engraved plates may be manufactured by techniques known in the art. Manufacturing techniques of engraved intaglio plates include hand-graving and computer based technologies such as CTiP (“Computer to Intaglio Plate”), DLE (“Direct Laser Engraving”) and FIT (“Fine Intaglio Technology”). Typically, the engraved intaglio plate temperature is in the range from about 30° C. and about 90° C. To this end, the plate cylinder may be thermo-regulated.

When the one or more inks described herein are transferred from the one or more chablon cylinders described herein or from the collecting cylinder described herein into the engravings of the intaglio plate, some excess ink is also transferred onto the non-engraved surface of the plate. The present invention thus provides a method to reduce the excess ink and therefore strongly reduces the amount of intaglio ink wiped off and discarded during the wiping process of the intaglio plate. The excess ink on the surface of the plate cylinder may be removed either by cleaning the cylinder carrying the intaglio plate with a wiping cylinder and a cleaning solution or alternatively, the excess ink on the surface of the cylinder is removed from the cylinder by using a disposable fibrous material such as for example a paper or a tissue. Since the use of these fibrous materials results in massive quantities of ink-impregnated waste to dispose of, representing potential environmental hazards, it is preferred that the excess ink on the surface of the plate cylinder is removed by cleaning the cylinder carrying the intaglio plate with a wiping cylinder and a cleaning solution. Wiping cylinders are typically made of polyvinyl chloride (PVC) or rubber. When a wiping cylinder is used, the wiping cylinder, in turn, is cleaned in a bath comprising a solvent or an aqueous solution. Typically, suitable washing solutions for cleaning wiping cylinders are alkaline aqueous wiping solutions comprising between about 0.3 wt-% and about 1.2 wt-% of a strong base, such as e.g. sodium hydroxide NaOH, and between about 0.3 wt-% and 1 about wt-% of a surfactant, such as e.g. sulfated castor oil (SCO), the weight percents being based on the total weight of the alkaline aqueous wiping solution. Consequently, suitable inks for the present invention exhibit detergeability in the alkaline aqueous wiping solutions described hereabove.

The remaining ink in the engravings of the one or more intaglio engraved plates is then transferred under pressure onto a substrate to be printed. During the printing process, high pressure applied between the plate cylinder carrying the one or more intaglio engraved plates and the substrate causes deformation as well as embossing of said substrate. The high pressure, typically of several tens to several hundreds of bars, is applied with a counter-pressure cylinder located on the opposite side of the substrate.

The one or more inks described herein may be hardened and/or cured as known to the skilled person by different methods. The term “curing” refers to processes including the drying or solidifying or reacting (e.g. chemical reactions, crosslinkings and/or polymerizations) of the applied ink in such a manner that the ink can no longer be removed from the surface onto which it is applied. Depending on the composition of the ink described herein, i.e. if the ink is a radiation curable ink, an oxidatively drying intaglio ink or a combination thereof, the hardening or curing step may be achieved by different processes. Should the ink be a radiation curable ink, hardening or curing step may be carried out by means of radiation energy including, without limitation, UV-Vis-light and/or electron beam. Should the ink be an oxidatively drying intaglio ink, hardening or curing step may be carried out by the action of oxygen, for instance oxygen from the air (“air-drying”).

In one embodiment of the present invention, the process for intaglio printing a feature or pattern, preferably a security feature or security pattern, described herein may be advantageously performed with inks having a viscosity falling within the range between about 0.1 Pa·s and about 10 Pa·s at 25° C. and at a shear rate of 1000 s⁻¹, preferably between about 0.1 Pa·s and about 5 Pa·s at 25° C. and 1000 s⁻¹, and within the range between about 0.1 Pa·s and about 30 Pa·s at 25° C. and at a shear rate of 100 s⁻¹, preferably between about 0.1 and about 20 Pa·s at 25° C. and at a shear rate of 100 s⁻¹, and comprising particles having a size (d50) up to about 90 microns, preferably between about 2 microns to about 90 microns and more preferably between about 3 microns to about 60 microns.

As described hereabove, the one or more inks described herein may be selected from the group consisting of radiation curable inks, thermal drying compositions, oxidatively drying intaglio inks and combinations thereof.

As described hereabove, the one or more inks described herein comprise particles having a size (d50) up to about 90 microns, preferably between about 2 microns to about 90 microns and more preferably between about 3 microns to about 60 microns. The particles having such a size are preferably present in an amount from about 10 wt-% to about 40 wt-%, and more preferably in an amount between about 10 wt-% and about 30 wt-%, the weight percent being based on the total weight of the ink.

According to one embodiment, at least some of the particles comprised in the one or more inks described herein are optically variable pigment particles having a size (d50) up to about 90 microns, preferably between about 2 microns to about 90 microns and more preferably between about 3 microns to about 60 microns. According to another embodiment, at least a part of the particles comprised in the one or more inks described herein is constituted by magnetic or magnetizable pigment particles having a size (d50) up to about 90 microns, preferably between about 2 microns to about 90 microns, more preferably between about 3 microns to about 60 microns, or is constituted by a mixture comprising optically variable pigment particles and magnetic or magnetizable pigment particles having a size (d50) up to about 90 microns, preferably between about 2 microns to about 90 microns and more preferably between about 3 microns to about 60 microns.

Optically variable pigment particles are preferably selected from the group consisting of thin film interference pigments, interference coated pigments, cholesteric liquid crystal pigments and mixtures thereof.

Magnetic or magnetizable pigment particles are preferably optically variable magnetic or magnetizable pigment particles preferably selected from the group consisting of magnetic thin-film interference pigments, magnetic cholesteric liquid crystal pigments, interference coated pigments comprising a magnetic material and mixtures thereof. When present, the optically variable pigment particles and/or optically variable magnetic or magnetizable pigment particles are preferably present in an amount from about 10 wt-% to about 40 wt-%, and more preferably in an amount between about 10 wt-% and about 30 wt-%, the weight percent being based on the total weight of the ink. The optically variable pigment particles and the optically variable magnetic or magnetizable pigment particles described herein typically have a platelet shape (e.g flakes). For the aspect ration of their shape, reference is made to the above description.

Suitable thin-film interference pigments exhibiting optically variable characteristics are known to those skilled in the art and disclosed in U.S. Pat. No. 4,705,300; U.S. Pat. No. 4,705,356; U.S. Pat. No. 4,721,271; U.S. Pat. No. 5,084,351; U.S. Pat. No. 5,214,530; U.S. Pat. No. 5,281,480; U.S. Pat. No. 5,383,995; U.S. Pat. No. 5,569,535, U.S. Pat. No. 5,571,624 and in the documents related to these. When at least a part of the of optically variable pigment particles is constituted by thin film interference pigments, it is preferred that the thin film interference pigments comprise a Fabry-Perot reflector/dielectric/absorber multilayer structure and more preferably a Fabry-Perot absorber/dielectric/reflector/dielectric/absorber multilayer structure, wherein the absorber layers are partially transmitting and partially reflecting, the dielectric layers are transmitting and the reflective layer is reflecting the incoming light. Preferably, the reflector layer is selected from the group consisting of metals, metal alloys and combinations thereof, preferably selected from the group consisting of reflective metals, reflective metal alloys and combinations thereof and more preferably selected from the group consisting of aluminum (Al), chromium (Cr), nickel (Ni), and mixtures thereof and still more preferably aluminum (Al). Preferably, the dielectric layers are independently selected from the group consisting of magnesium fluoride (MgF₂), silicium dioxide (SiO₂) and mixtures thereof and more preferably magnesium fluoride (MgF₂). Preferably, the absorber layers are independently selected from the group consisting of chromium (Cr), nickel (Ni), metallic alloys and mixtures thereof and more preferably chromium (Cr). When at least a part of the optically variable pigment particles is constituted by thin film interference pigments, it is particularly preferred that the thin film interference pigments comprise a Fabry-Perot absorber/dielectric/reflector/dielectric/absorber multilayer structure consisting of a Cr/MgF₂/Al/MgF₂/Cr multilayer structure. Preferred thin film interference pigments exhibiting optically variable characteristics for the present invention are flakes having a d50 value between about 3 microns and about 50 microns.

Liquid crystals in the cholesteric phase exhibit a molecular order in the form of a helical superstructure perpendicular to the longitudinal axes of its molecules. The helical superstructure is at the origin of a periodic refractive index modulation throughout the liquid crystal material, which in turn results in a selective transmission/reflection of determined wavelengths of light (interference filter effect). Cholesteric liquid crystal polymers can be obtained by subjecting one or more crosslinkable substances (nematic compounds) with a chiral phase to alignment and orientation. The particular situation of the helical molecular arrangement leads to cholesteric liquid crystal materials exhibiting the property of reflecting a circularly polarized light component within a determined wavelength range. The pitch (i.e. the distance over which a full rotation of 360° of the helical arrangement is completed) can be tuned in particular by varying selectable factors including the temperature and solvents concentration, by changing the nature of the chiral component(s) and the ratio of nematic and chiral compounds. Crosslinking under the influence of UV radiation freezes the pitch in a predetermined state by fixing the desired helical form so that the color of the resulting cholesteric liquid crystal materials is no longer depending on external factors such as the temperature. Cholesteric liquid crystal materials may then be shaped to cholesteric liquid crystal pigments by subsequently comminuting the polymer to the desired particle size. Examples of films and pigments made from cholesteric liquid crystal materials and their preparation are disclosed in U.S. Pat. No. 5,211,877; U.S. Pat. No. 5,362,315 and U.S. Pat. No. 6,423,246 and in EP 1 213 338 B1; EP 1 046 692 B1 and EP 0 601 483 B1. Preferred cholesteric liquid crystal pigments for the present invention are flakes having a d50 value between about 5 microns and about 50 microns.

Suitable interference coated pigments include, without limitation, structures comprising a substrate selected from the group consisting of metallic cores such as titanium, silver, aluminum, copper, chromium, iron, germanium, molybdenum, tantalum or nickel coated with one or more layers made of metal oxides as well as structure consisting of a core made of synthetic or natural micas, other layered silicates (e.g. talc, kaolin and sericite), glasses (e.g. borosilicates), silicium dioxides (SiO₂), aluminum oxides (Al₂O₃), titanium oxides (TiO₂), graphites and mixtures thereof coated with one or more layers made of metal oxides (e.g. titanium oxides, zirconium oxides, tin oxides, chromium oxides, nickel oxides, copper oxides and iron oxides). The structures described hereabove have been described for example in Chem. Rev. 99 (1999), G. Pfaff and P. Reynders, pages 1963-1981 and WO 2008/083894 A2. Typical examples of these interference coated pigments include without limitation silicium oxide cores coated with one or more layers made of titanium oxide, tin oxide and/or iron oxide; natural or synthetic mica cores coated with one or more layers made of titanium oxide, silicium oxide and/or iron oxide, in particular mica cores coated with alternate layers made of silicium oxide and titanium oxide; borosilicate cores coated with one or more layers made of titanium oxide, silicium oxide and/or tin oxide; and titanium oxide cores coated with one or more layers made of iron oxide, iron oxide-hydroxide, chromium oxide, copper oxide, cerium oxide, aluminum oxide, silicium oxide, bismuth vanadate, nickel titanate, cobalt titanate and/or antimony-doped, fluorine-doped or indium-doped tin oxide; aluminum oxide cores coated with one or more layers made of titanium oxide and/or iron oxide. Preferred interference coated pigments for the present invention have a d50 value between about 5 microns and about 60 microns.

As mentioned hereabove, the one or more inks may comprise the magnetic or magnetizable pigment particles, preferably the optically variable magnetic or magnetizable pigment particles described herein. Due to their magnetic characteristics being machine readable, inks comprising magnetic or magnetizable pigment particles, preferably optically variable magnetic or magnetizable pigment particles may be detected for example with the use of specific magnetic detectors. Therefore, inks comprising optically variable magnetic or magnetizable pigment particles may be used as a covert or semi-covert security element (those requiring an authentication tool to be verified) for any article comprising said inks, in particular security documents comprising said inks.

Suitable magnetic thin film interference pigments exhibiting optically variable characteristics are known to those skilled in the art and disclosed in U.S. Pat. No. 4,838,648; WO 2002/073250 A2; EP 686 675 B1; WO 2003/00801 A2; U.S. Pat. No. 6,838,166; WO 2007/131833 A1 and in the documents related thereto. Preferably, the optically variable magnetic or magnetizable pigment particles are magnetic thin film interference pigments consisting of pigments having a five-layer Fabry-Perot multilayer structure and/or pigments having a six-layer Fabry-Perot multilayer structure and/or pigments having a seven-layer Fabry-Perot multilayer structure. Preferred five-layer Fabry-Perot multilayer structures consist of absorber/dielectric/reflector/dielectric/absorber multilayer structures wherein the reflector and/or the absorber is also a magnetic layer. Preferred six-layer Fabry-Perot multilayer structures consist of absorber/dielectric/reflector/magnetic/dielectric/absorber multilayer structures, said multilayer structure preferably consisting of Cr/MgF₂/Al/magnetic/MgF₂/Cr multilayer structures. Preferred seven-layer Fabry Perot multilayer structures consist of absorber/dielectric/reflector/magnetic/reflector/dielectric/absorber multilayer structures such as disclosed in U.S. Pat. No. 4,838,648; and more preferably seven-layer Fabry-Perot absorber/dielectric/reflector/magnetic/reflector/dielectric/absorber multilayer structures. Preferably, the reflector layers described herein are selected from the group consisting of metals, metal alloys and combinations thereof, preferably selected from the group consisting of reflective metals, reflective metal alloys and combinations thereof, and more preferably from the group consisting of aluminum (Al), chromium (Cr), nickel (Ni), and mixtures thereof and still more preferably aluminum (Al). Preferably, the dielectric layers are independently selected from the group consisting of magnesium fluoride (MgF₂), silicium dioxide (SiO₂) and mixtures thereof, and more preferably magnesium fluoride (MgF₂). Preferably, the absorber layers are independently selected from the group consisting of chromium (Cr), nickel (Ni), metallic alloys and mixtures thereof. Preferably, the magnetic layer is preferably selected from the group consisting of nickel (Ni), iron (Fe) and cobalt (Co), alloys comprising nickel (Ni), iron (Fe) and/or cobalt (Co), and mixtures thereof. It is particularly preferred that the magnetic thin film interference pigments consist of a seven-layer Fabry-Perot absorber/dielectric/reflector/magnetic/reflector/dielectric/absorber multilayer structure of a Cr/MgF₂/Al/Ni/Al/MgF₂/Cr multilayer structure. Magnetic thin film interference pigments described herein are typically manufactured by vacuum deposition of the different required layers onto a web. After deposition of the desired number of layers, e.g. by PVD, the stack of layers is removed from the web, either by dissolving a release layer in a suitable solvent, or by stripping the material from the web. The so-obtained material is then broken down to flakes which have to be further processed by grinding, milling or any suitable method. The resulting product consists of flat flakes with broken edges, irregular shapes and different aspect ratios. Further information on the preparation of suitable magnetic thin film interference pigments can be found e.g. in EP 1 710 756 A1. Preferred magnetic thin film interference pigments exhibiting optically variable characteristics for the present invention are flakes having a diameter comprised between about 2 microns and about 50 microns, preferably between about 3 microns and about 50 microns.

Suitable magnetic cholesteric liquid crystal pigments exhibiting optically variable characteristics include without limitation monolayered cholesteric liquid crystal pigments and multilayered cholesteric liquid crystal pigments and are disclosed for example in WO 2006/063926 A1, U.S. Pat. No. 6,582,781 and U.S. Pat. No. 6,531,221. WO 2006/063926 A1 discloses monolayers and pigments obtained therefrom with high brilliance and colorshifting properties with additional particular properties such as magnetizability. The disclosed monolayers and pigments obtained therefrom by comminuting said monolayers comprise a three-dimensionally crosslinked cholesteric liquid crystal mixture and magnetic nanoparticles. U.S. Pat. No. 6,582,781 and U.S. Pat. No. 6,410,130 disclose platelet-shaped cholesteric multilayer pigments which comprise the sequence A¹/B/A², wherein A¹ and A² may be identical or different and each comprises at least one cholesteric layer, and B is an interlayer absorbing all or some of the light transmitted by the layers A¹ and A² and imparting magnetic properties to said interlayer. U.S. Pat. No. 6,531,221 discloses platelet-shaped cholesteric multilayer pigment which comprise the sequence A/B and if desired C, wherein A and C are absorbing layers comprising pigments imparting magnetic properties, and B is a cholesteric layer. The disclosed platelet-shaped cholesteric multilayer pigments typically have a d50 value between about 3 microns and about 50 microns.

Suitable interference coated pigments comprising a magnetic material consist of the interference coated pigments described hereabove, wherein the pigment comprise a magnetic material.

When the one or more inks described herein comprise the magnetic or magnetizable pigment particles, preferably the optically variable magnetic or magnetizable pigment particles, described herein, the process described herein may further comprise a step of orienting said pigment particles after application of the one or more inks on the substrate, i.e. after the step of transferring to the substrate (step iii)) and before the hardening or curing step (step iv)), through the application of an appropriate magnetic field. The so-oriented pigments particles are fixed in their respective positions and orientations by hardening or curing the applied ink. During the step of exposing the one or more inks comprising the magnetic or magnetizable pigment particles described herein and/or the optically variable magnetic or magnetizable pigment particles described herein applied to the substrate to a magnetic field, hereby orienting the pigment particles, the one or more inks are still sufficiently liquid so that the pigment particles can be moved and oriented. The step of magnetically orienting the magnetic or magnetizable pigment particles described herein and/or the optically variable magnetic or magnetizable pigment particles described herein consists of a step of exposing the applied ink, while it is sufficiently liquid so that the pigment particles can be moved and oriented, to an appropriate and determined magnetic field generated at a surface of a magnetic-field-generating device, thereby orienting the pigment particles along field lines of the magnetic field, i.e. a step of bringing the one or more inks sufficiently close or in contact with the magnetic-field-generating device. This approaching or bringing close together allows the magnetic or magnetizable pigment particles described herein and/or the optically variable magnetic or magnetizable pigment particles described herein in the one or more inks to be oriented with respect to the magnetic field.

The magnetic field may be applied either i) from the side of the substrate which carries the one or more inks, or ii) from the side of the substrate opposite to the one or more inks, or iii) from one or several directions that differ from the normal to the surface of the substrate carrying the one or more inks. Here, applying the magnetic field from a specified side or direction means that the device that generates the magnetic field is physically located at a specified distance from the substrate along said direction or on said side of the substrate. The magnetic field generating device may be a permanent magnet, as set of permanent magnet and/or pole pieces, or solenoids and/or pole pieces. Noteworthy, the one or more inks applied on the substrate may practically be brought into contact with the magnetic device. Alternatively, an air gap, or an intermediate separating layer may be provided. By appropriately shaping the field lines of the magnetic field, the optically variable magnetic or magnetizable pigment particles can be oriented in a pattern producing a corresponding magnetically induced image or pattern which can be very difficult, if not impossible to reproduce or counterfeit without an appropriate, not widely available, material. Materials and technology for the orientation of magnetic particles in an ink or a coating composition, and corresponding combined printing/magnetic orienting processes have been disclosed in U.S. Pat. No. 2,418,479; U.S. Pat. No. 2,570,856; U.S. Pat. No. 3,791,864; DE-A 2006848; U.S. Pat. No. 3,676,273; U.S. Pat. No. 5,364,689; U.S. Pat. No. 6,103,361; US 2004/0051297; US 2004/0009309; EP 0 710 508 A1, WO 2002/090002 A2; WO 2003/000801 A2; WO 2005/002866 A1, and US 2002/0160194. The magnetic-field-generating device may comprise a magnetic plate which may furthermore carry surface relief, engravings or cut-outs. For example, WO 2005/002866 A1 and WO 2008/046702 A1 disclose examples of engraved magnetic plates.

According to one embodiment, the one or more inks described herein are radiation curable inks. Radiation curable inks consist of inks that may be cured by radiation with light having a wavelength in the UV-Vis range (hereafter referred as UV-Vis-curable) or by E-beam radiation (hereafter referred as EB). Radiation curable inks are known in the art and can be found in standard textbooks such as the series “Chemistry & Technology of UV & EB Formulation for Coatings, Inks & Paints”, published in 7 volumes in 1997-1998 by John Wiley & Sons in association with SITA Technology Limited. Radiation curing, in particular UV-Vis curing, advantageously leads to very fast curing processes and hence drastically decreases the drying time of inks thus allowing a high production rate while preventing set-off and blocking issues.

Furthermore, when the ink described herein comprise particles that are magnetic or magnetizable so as to be oriented, radiation curing, in particular UV-Vis curing, advantageously leads to an instantaneous increase in viscosity of the ink after exposure to the curing radiation, thus preventing any further movement of the particles and in consequence any loss of information after the magnetic orientation step.

The UV-Vis-curable inks described herein comprise one or more binders and preferably one or more photoinitiators and/or sensitizers. Preferably the one or more binders of the UV-Vis-curable ink described herein are prepared from one or more compounds selected from the group consisting of radically curable compounds, cationically curable compounds and mixtures thereof. Cationically curable compounds are cured by cationic mechanisms consisting of the activation by energy of one or more photoinitiators which liberate cationic species, such as acids, which in turn initiate the polymerization so as to form the binder. Radically curable compounds are cured by free radical mechanisms consisting of the activation by energy of one or more photoinitiators which liberate free radicals which in turn initiate the polymerization so as to form the binder. Preferably, the one or more binders of the UV-Vis-curable ink described herein are prepared from compounds selected from the group consisting of (meth)acrylates, vinyl ethers, propenyl ethers, cyclic ethers such as epoxides, oxetanes, tetrahydrofuranes, lactones, cyclic thioethers, vinyl and propenyl thioethers, hydroxyl-containing compounds and mixtures thereof. More preferably, the one or more binders of the UV-Vis-curable ink described herein are prepared from compounds selected from the group consisting of (meth)acrylates, vinyl ethers, propenyl ethers, cyclic ethers such as epoxides, oxetanes, tetrahydrofuranes, lactones and mixtures thereof.

According to one embodiment, the one or more binders of the UV-Vis-curable ink described herein are prepared from radically curable compounds selected from (meth)acrylates, preferably selected from the group consisting of epoxy (meth)acrylates, polyester (meth)acrylates, aliphatic or aromatic urethane (meth)acrylates, silicone (meth)acrylates, amino (meth)acrylates, acrylic (meth)acrylates and mixtures thereof. The term “(meth)acrylate” in the context of the present invention refers to the acrylate as well as the corresponding methacrylate. The one or more binders of the UV-Vis-curable ink described herein may be prepared with additional vinyl ethers and/or monomeric acrylates such as for example trimethylolpropane triacrylate (TMPTA), pentaerytritol triacrylate (PTA), tripropyleneglycoldiacrylate (TPGDA), dipropyleneglycoldiacrylate (DPGDA), hexanediol diacrylate (HDDA) and their polyethoxylated equivalents such as for example polyethoxylated trimethylolpropane triacrylate, polyethoxylated pentaerythritol triacrylate, polyethoxylated tripropyleneglycol diacrylate, polyethoxylated dipropyleneglycol diacrylate and polyethoxylated hexanediol diacrylate.

According to another embodiment, the one or more binders of the UV-Vis-curable ink described herein are prepared from cationically curable compounds selected from the group consisting of vinyl ethers, propenyl ethers, cyclic ethers such as epoxides, oxetanes, tetrahydrofuranes, lactones, cyclic thioethers, vinyl and propenyl thioethers, hydroxyl-containing compounds and mixtures thereof, preferably cationically curable compounds selected from the group consisting of vinyl ethers, propenyl ethers, cyclic ethers such as epoxides, oxetanes, tetrahydrofuranes, lactones and mixtures thereof. Typical examples of epoxides include without limitation glycidyl ethers, □-methyl glycidyl ethers of aliphatic or cycloaliphatic diols or polyols, glycidyl ethers of diphenols and polyphenols, glycidyl esters of polyhydric phenols, 1,4-butanediol diglycidyl ethers of phenolformalhedhyde novolak, resorcinol diglycidyl ethers, alkyl glycidyl ethers, glycidyl ethers comprising copolymers of acrylic esters (e.g. styrene-glycidyl methacrylate or methyl methacrylate-glycidyl acrylate), polyfunctional liquid and solid novolak glycidyl ethers resins, polyglycidyl ethers and poly(□-methylglycidyl) ethers, poly(N-glycidyl) compounds, poly(S-glycidyl) compounds, epoxy resins in which the glycidyl groups or methyl glycidyl groups are bonded to hetero atoms of different types, glycidyl esters of carboxylic acids and polycarboxylic acids, limonene monoxide, epoxidized soybean oil, bisphenol-A and bisphenol-F epoxy resins. Examples of suitable epoxides are disclosed in EP 2 125 713 B1. Suitable examples of aromatic, aliphatic or cycloaliphatic vinyl ethers include without limitation compounds having at least one, preferably at least two, vinyl ether groups in the molecule. Examples of vinyl ethers include without limitation triethylene glycol divinyl ether, 1,4-cyclohexanedimethanol divinyl ether, 4-hydroxybutyl vinyl ether, propenyl ether of propylene carbonate, dodecyl vinyl ether, tert-butyl vinyl ether, tert-amyl vinyl ether, cyclohexyl vinyl ether, 2-ethylhexyl vinyl ether, ethylene glycol monovinyl ether, butanediol monovinyl ether, hexanediol monovinyl ether, 1,4-cyclohexanedimethanol monovinyl ether, diethylene glycol monovinyl ether, ethylene glycol divinyl ether, ethylene glycol butylvinyl ether, butane-1,4-diol divinyl ether, hexanediol divinyl ether, diethylene glycol divinyl ether, triethylene glycol divinyl ether, triethylene glycol methylvinyl ether, tetraethylene glycol divinyl ether, pluriol-E-200 divinyl ether, polytetrahydrofuran divinyl ether-290, trimethylolpropane trivinyl ether, dipropylene glycol divinyl ether, octadecyl vinyl ether, (4-cyclohexyl-methyleneoxyethene)-glutaric acid methyl ester and (4-butoxyethene)-iso-phthalic acid ester. Examples of hydroxy-containing compounds include without limitation polyester polyols such as for example polycaprolactones or polyester adipate polyols, glycols and polyether polyols, castor oil, hydroxy-functional vinyl and acrylic resins, cellulose esters, such as cellulose acetate butyrate, and phenoxy resins. Further examples of suitable cationically curable compounds are disclosed in EP 2 125 713 B1 and EP 0 119 425 B1.

Alternatively, the one or more binders of the UV-Vis-curable inks described herein are hybrid binders and may be prepared from mixtures comprising radically curable compounds and cationically curable compounds such as those described herein as well as their respective photoinitiators described herein. The radically curable binder compounds may be present in an amount from about 1 wt-% to about 99 wt-% and the cationically curable binder compounds may be present in an amount from about 1 wt-% to about 99 wt-%, the weight percents being based on the total weight of the binder of UV-Vis-curable intaglio ink compositions.

UV-Vis curing of a monomer, oligomer or prepolymer may require the presence of one or more photoinitiators and may be performed in a number of ways. As known by those skilled in the art, the one or more photoinitiators are selected according to their absorption spectra and are selected to fit with the emission spectra of the radiation source. Depending on the monomers, oligomers or prepolymers used to prepare the binder comprised in the UV-Vis-curable optically variable compositions described herein, different photoinitiators might be used. Suitable examples of free radical photoinitiators are known to those skilled in the art and include without limitation acetophenones, benzophenones, alpha-aminoketones, alpha-hydroxyketones, phosphine oxides and phosphine oxide derivatives and benzyldimethyl ketals. Suitable examples of cationic photoinitiators are known to those skilled in the art and include without limitation onium salts such as organic iodonium salts (e.g. diaryl iodoinium salts), oxonium (e.g. triaryloxonium salts) and sulfonium salts (e.g. triarylsulfonium salts). Other examples of useful photoinitiators can be found in standard textbooks such as “Chemistry & Technology of UV & EB Formulation for Coatings, Inks & Paints”, Volume III, “Photoinitiators for Free Radical Cationic and Anionic Polymerization”, 2nd edition, by J. V. Crivello & K. Dietliker, edited by G. Bradley and published in 1998 by John Wiley & Sons in association with SITA Technology Limited. The one or more photoinitiators comprised in the UV-Vis-curable ink are preferably present in an amount from about 0.1 wt-% to about 20 wt-%, more preferably about 1 wt-% to about 15 wt-%, the weight percents being based on the total weight of the UV-Vis-curable ink. It may also be advantageous to include a sensitizer in conjunction with the one or more photoinitiators in order to achieve efficient curing. Typical examples of suitable photosensitizers include without limitation isopropyl-thioxanthone (ITX), 1-chloro-2-propoxy-thioxanthone (CPTX), 2-chloro-thioxanthone (CTX) and 2,4-diethyl-thioxanthone (DETX) and mixtures thereof. When present, the one or more photosensitizers are preferably present in an amount from about 0.1 wt-% to about 15 wt-%, more preferably about 0.5 wt-% to about 5 wt-%, the weight percents being based on the total weight of the UV-Vis-curable ink.

The UV-Vis-curable inks described herein may further comprise one or more diluents. As used herein, the optional “diluents” consist of one or more low molecular weights and low viscosity monomer or oligomers. Typically the one or more diluents comprise one or more reactive moieties that may react with the binder components during the UV-Vis curing process. Thus preferably the diluents are reactive diluents that comprise one, two or more functional moieties. The one or more reactive diluents are used as viscosity cutting agents to reduce the viscosity of in the ink.

Alternatively, dual-cure inks may be used; these inks combine thermal drying and radiation curing mechanisms. Typically, such compositions are similar to radiation curing compositions such as those described herein but include a volatile part constituted by water and/or solvent. These volatile constituents are first evaporated using hot air or IR driers, and UV drying is then completing the curing process.

According to one embodiment, the one or more inks described herein are oxidatively drying inks. Oxidative drying inks refer to inks which dry by oxidation in the presence of oxygen, in particular in the presence of the oxygen of the atmosphere (“air-drying”). Alternatively, in order to accelerate the drying process, the drying process may be performed under hot air, infrared or combination of hot air and infrared. During the drying process, the oxygen combines with one or more components of the ink binder, converting the ink to a semi-solid or a solid state. The oxidatively drying inks described herein comprise at least a binder and one or more oxidative driers (also referred in the art as driers, oxypolymerization catalysts, siccativating agents and siccatives).

The binders are typically polymers comprising unsaturated fatty acid residues, saturated fatty acids residues or mixtures thereof. Preferably the binders described herein comprise unsaturated fatty acid residues to ensure the air drying properties. Particularly preferred are resins comprising unsaturated acid groups, even more preferred are resins comprising unsaturated carboxylic acid groups. However the resins may also comprise saturated fatty acids residues. Preferably the binders described herein comprise acid groups, i.e. the binders are selected among acid modified resins. The binders described herein may be selected from the group consisting of alkyd resins, vinyl polymers, polyurethane resins, hyperbranched resins, rosin-modified maleic resins, terpene resins, nitrocellulose resins, polyolefins, polyamides, acrylic resins and mixtures thereof. Polymers and resins are herein interchangeable terms.

Saturated and unsaturated fatty acid compounds may be obtained from natural and/or artificial sources. Natural sources include animal sources and/or plant sources. Animal sources may comprise animal fat, butter fat, fish oil, lard, liver fats, tuna fish oil, sperm whale oil and/or tallow oil and waxes. Plant sources may comprise waxes and/or oils such as vegetable oils and/or non-vegetable oils. Examples of plant oils include without limitation bitter gourd, borage, calendula, canola, castor, china wood, coconut, conifer seed, corn, cottonseed, dehydrated castor, flaxseed, grape seed, Jacaranda mimosifolia seed, linseed oil, palm, palm kernel, peanut, pomegranate seed, rapeseed, safflower, snake gourd, soya (bean), sunflower, tung, and/or wheat germ. Artificial sources include synthetic waxes (such as micro crystalline and/or paraffin wax), distilling tail oils and/or chemical or biochemical synthesis methods. Suitable fatty acids also include (Z)-hexadan-9-enoic[palmitoleic]acid (C₁₆H₃₀O₂), (Z)-octadecan-9-enoic[oleic]acid (C₁₈H₃₄O₂), (9Z,11E,13E)-octadeca-9,11,13-trienoic[□-eleostearic]acid (C₁₈H₃₀O₂), licanic acid, (9Z,12Z)-octadeca-9,12-dienoic[linoeic]acid (C₁₈H₃₂O₂), (5Z,8Z,11Z,14Z)-eicosa-5,8,11,14-tetraenoic[arachidonic]acid (C₂₀H₃₂O₂), 12-hydroxy-(9Z)-octadeca-9-enoic[ricinoleic]acid (C₁₈H₃₄O₃), (Z)-docosan-13-enoic[erucic]acid (C₂₂H₄₂O₃), (Z)-eicosan-9-enoic[gadoleic]acid (C₂₀H₃₈O₂), (7Z,10Z,13Z,16Z,19Z)-docosa-7,10,13,16,19-pentaenoic[clupanodonic] acid and mixtures thereof.

Suitable fatty acids include ethylenically unsaturated conjugated or non-conjugated C2-C24 carboxylic acids, such as myristoleic, palmitoleic, arachidonic, erucic, gadoleic, clupanadonic, oleic, ricinoleic, linoleic, linolenic, licanic, nisinic acid and eleostearic acids and mixtures thereof, typically used in the form of mixtures of fatty acids derived from natural or synthetic oils.

Suitable oxidative driers are known in the art. Oxidative driers are for example metal salts acting as catalysts for auto-oxidation reaction which is initiated on drying. Typical examples of oxidative driers include without limitations compounds such as polyvalent salts containing cobalt, calcium, copper, zinc, iron, zirconium, manganese, barium, zinc, strontium, lithium, vanadium and potassium as the cation; and halides, nitrates, sulfates, carboxylates such as acetates, ethylhexanoates, octanoates and naphtenates or acetoacetonates as the anions. Examples of oxidative driers may be found e.g. in WO 2011/098583 A1 or in WO 2009/007988 A1 and the documents related thereto. The one or more oxidative driers are preferably present in an amount from about 0.01 wt-% to about 15 wt-%, the weight percent being based on the total weight of the oxidatively drying intaglio inks.

The oxidatively drying intaglio inks described herein may further comprise a liquid medium. As used herein, the optional “liquid medium” consists of one or more organic solvents. Examples of such solvents include without limitation alcohols (such as for example methanol, ethanol, isopropanol, n-propanol, ethoxy propanol, n-butanol, sec-butanol, tert-butanol, iso-butanol, 2-ethylhexyl-alcohol and mixtures thereof); polyols (such as for example glycerol, 1,5-pentanediol, 1,2,6-hexanetriol and mixtures thereof); esters (such as for example ethyl acetate, n-propyl acetate, n-butyl acetate and mixtures thereof); carbonates (such as for example dimethyl carbonate, diethylcarbonate, di-n-butylcarbonate, 1,2-ethylencarbonate, 1,2-propylenecarbonate, 1,3-propylencarbonate and mixtures thereof); aromatic solvents (such as for example toluene, xylene and mixtures thereof); ketones and ketone alcohols (such as for example acetone, methyl ethyl ketone, methyl isobutyl ketone, cyclohexanone, diacetone alcohol and mixtures thereof); amides (such as for example dimethylformamide, dimethyl-acetamide and mixtures thereof); aliphatic or cycloaliphatic hydrocarbons; chlorinated hydrocarbons (such as for example dichloromethane); nitrogen-containing heterocyclic compound (such as for example N-methyl-2-pyrrolidone, 1,3-dimethyl-2-imidazolidone and mixtures thereof); ethers (such as for example diethyl ether, tetrahydrofuran, dioxane and mixtures thereof); alkyl ethers of a polyhydric alcohol (such as for example 2-methoxyethanol, 1-methoxypropan-2-ol and mixtures thereof); alkylene glycols, alkylene thioglycols, polyalkylene glycols or polyalkylene thioglycols (such for example ethylene glycol, polyethylene glycol (such as for example diethylene glycol, triethylene glycol, tetraethylene glycol), propylene glycol, polypropylene glycol (such as for example dipropylene glycol, tripropylene glycol), butylene glycol, thiodiglycol, hexylene glycol and mixtures thereof); nitriles (such as for example acetonitrile, propionitrile and mixtures thereof), and sulfur-containing compounds (such as for example dimethylsulfoxide, sulfolan and mixtures thereof.

Alternatively, dual-cure inks may be used; these inks combine oxidative drying mechanisms and radiation curing mechanisms. Such a combination is also referred in the art of “UVOX”.

With the aim of having an easy cleaning of the wiping cylinder using the alkaline aqueous wiping solutions described hereabove, the one or more inks described herein may further comprise one or more surfactants. The one or more surfactants may be non-ionic surfactants, anionic surfactants, cationic surfactants or zwitterionic surfactants and may be macromolecular surfactants (also referred in the art as polymeric surfactants) or low molecular weight surfactants. When present, the one or more surfactant are preferably present in an amount from about 1 wt-% to about 20 wt-%, the weight percents being based on the total weight of the ink. Preferably the one or more surfactants described herein are macromolecular surfactants which may be non-ionic surfactants, anionic surfactants, cationic surfactants or zwitterionic surfactants. The term “macromolecular surfactant” as used herein shall be understood as defined e.g. by M. B. Rosen in “Surfactants and Interfacial Phenomena” (John Wiley & Sons 1978). Suitable macromolecular surfactants for the invention have a number average molecular weight in the range between about 1000 and about 150000, preferably from about 3000 to about 20000. The functional groups attached to these macromolecular surfactants are for example carboxylic or sulfonic acid groups, hydroxyl groups, ether groups or primary, secondary, tertiary or quaternary amino groups. The acid groups may be neutralized with organic bases such as amines and alcanolamines, inorganic bases or combinations thereof. Alternatively, macromolecular surfactants carrying non-neutralized acidic groups may be used, said non-neutralized acidic groups being only neutralized when put in contact with the alkaline aqueous wiping solution such as to allow the cleaning the wiping cylinder. Primary, secondary and tertiary amino groups may be neutralized with organic acids such as for example sulfonic acids, formic acid, acetic acid and trifluoroacetic acid or inorganic acids.

Typical examples of nonionic macromolecular surfactants include without limitation the following compounds:

1. block copolymers containing polyether or polyamine sections.
2. copolymers based on vinylacetate and other vinyl-monomers of different molecular weight and degree of hydrolysis;
3. polyethers and adducts of amines with polyethers;
4. polyamines;
5. acrylamide type polymers or copolymers; and
6. polysaccarides and nonionic cellulose derivatives.

Typical examples of anionic macromolecular surfactants include without limitation products obtained by neutralization with organic and/or inorganic bases of the following polymers:

1. addition reaction products of fumaric acid or maleic anhydride to unsaturated vegetable oils, adducts of phenolic resins and vegetable oils, or polybutadiene type resins (acid number comprised between 10 and 250 mg KOH/g resin), polyamides, polyethers;
2. alkyd resins and modified alkyd resins (phenolic, epoxy, urethane, silicone, acrylic or vinylic modified alkyd resins) with acid numbers between 10 and 150 mg KOH/g resin.
3. epoxy resins and modified epoxy resins carrying carboxylic acid groups. The acid number is comprised between 30 and 200 mg KOH/g resin.
4. saturated polyester resins and modified saturated polyester resins with acid numbers between 50 and 250 mg KOH/g resin;
5. polymers and copolymers containing between 2% and 100% of acrylic acid and/or methacrylic acid and/or maleic acid and/or styrene sulfonic acid with acid numbers between 20 and 150 mg KOH/g resin;
6. condensation reaction products of rosin and rosin esters with vegetable oils and/or phenolic type resins; and
7. anionic type cellulose ethers.

Typical examples of cationic macromolecular surfactants include without limitation the following compounds:

1. salts of epoxy resins or modified epoxy resins carrying tertiary or secondary amino groups; and
2. salts of secondary and tertiary polyamines.

The one or more inks described herein may further comprise one or more fillers and/or extenders preferably selected from the group consisting of carbon fibers, talcs, mica (muscovite), wollastonites, calcinated clays, china clays, kaolins, carbonates (e.g. calcium carbonate, sodium aluminum carbonate), silicates (e.g. magnesium silicate, aluminum silicate), sulfates (e.g. magnesium sulfate, barium sulfate), titanates (e.g. potassium titanate), alumina hydrates, silica, fumed silica, montmorillonites, graphites, anatases, rutiles, bentonites, vermiculites, zinc whites, zinc sulfides, wood flours, quartz flours, natural fibers, synthetic fibers and combinations thereof. When present, the one or more fillers and/or extenders are preferably present in an amount from about 0.1 wt-% to about 40 wt-%, the weight percents being based on the total weight of the ink.

The one or more inks described herein may further comprise one or more waxes preferably selected from the group consisting of synthetic waxes, petroleum waxes and natural waxes. Preferably the one or more waxes are selected from the group consisting of microcrystalline waxes, paraffin waxes, polyethylene waxes, fluorocarbon waxes, polytetrafluoroethylene waxes, Fischer-Tropsch waxes, silicone fluids, beeswaxes, candelilla waxes, montan waxes, carnauba waxes and mixtures thereof. When present, the one or more waxes are preferably present in an amount from about 0.5 wt-% to about 10 wt-%, the weight percents being based on the total weight of the ink.

The one or more inks described herein may further comprise one or more machine readable materials. When present, the one or more machine readable materials are preferably selected from the group consisting of magnetic materials, luminescent materials, electrically conductive materials, infrared-absorbing materials and mixtures thereof. As used herein, the term “machine readable material” refers to a material which exhibits at least one distinctive property which is detectable by a device or a machine and which can be comprised in a layer so as to confer a way to authenticate said layer or article comprising said layer by the use of a particular equipment for its detection and/or authentication.

The one or more inks described herein may further comprise one or more coloring components selected from the group consisting of organic and inorganic pigments, dyes and mixtures thereof.

The one or more inks described herein may further comprise one or more additives including without limitation compounds and materials which are used for adjusting physical, rheological and chemical parameters of the composition such as the viscosity (e.g. solvents and surfactants), the consistency (e.g. anti-settling agents and plasticizers), the foaming properties (e.g. antifoaming agents), the lubricating properties (waxes), UV stability (photostabilizers) and adhesion properties, etc. Additives described herein may be present in one or more inks described herein in amounts and in forms known in the art, including in the form of so-called nano-materials where at least one of the dimensions of the additives is in the range of 1 to 1000 nm.

Preferably, the one or more inks described herein comprise from about 20 wt-% to about 60 wt-% of solid materials, i.e. the total amount of the particles described herein, preferably the optically variable pigment particles described herein, the optional fillers and/or extenders, the optional one or more waxes, the optional solid additives described herein, the optional photoinitiators and photosensitizers and the optional siccative compounds, the weight percent being based on the total weight of the ink.

The one or more inks described herein may be prepared by dispersing, mixing and/or milling the particles and the one or more additives when present in the presence of the one or more binders, thus forming liquid inks. When the one or more ink described herein are UV-Vis-curable inks, the one or more photoinitiators may be added to the composition either during the dispersing or mixing step of all other ingredients or may be added at a later stage, i.e. after the formation of the liquid inks.

Suitable substrates for the present invention include without limitation paper or other fibrous materials such as cellulose, paper-containing materials, plastic or polymer substrates, composite materials, metals or metalized materials, glasses, ceramics and combinations thereof. Typical examples of plastic or polymer substrates are substrates made of polypropylene (PP), polyethylene (PE), polycarbonate (PC), polyvinyl chloride (PVC) and polyethylene terephthalate (PET). Typical examples of composite materials include without limitation multilayer structures or laminates of paper and at least one plastic or polymer material such as those described hereabove as well as plastic and/or polymer fibers incorporated in a paper-like or fibrous material such as those described hereabove.

With the aim of further increasing the security level and the resistance against counterfeiting and illegal reproduction of security documents, the substrate may contain watermarks, security threads, fibers, planchettes, luminescent compounds, windows, foils, decals, coatings and combinations thereof.

The substrate described herein, on which the one or more inks described herein are applied, may consist of an intrinsic part of a security document, or alternatively, the one or more inks described herein are applied onto an auxiliary substrate such as for example a security thread, security stripe, a foil, a decal or a label and consequently transferred to a security document in a separate step. Those substrates and methods for applying ink compositions onto them are known in the art and do not have to be described in detail here.

Also described herein are printing assemblies comprising a) the one or more screen cylinders described herein, b) the one or more chablon cylinders described herein, and c) the plate cylinder carrying one or more intaglio engraved plates described herein. As mentioned hereabove for the process, the one or more chablon cylinders have a planar surface or comprise a plurality of recessed areas, preferably a plurality of recessed areas in the form of indicia. As mentioned hereabove for the process, the printing assembly may further comprise the collecting cylinder described herein; said collecting cylinder preferably being arranged between the one or more chablon cylinders and the plate cylinder.

Also described herein are uses of the one or more inks described herein in combination with the printing assembly described herein for printing a feature or pattern by an intaglio printing process, and more specifically for printing a security feature or security pattern.

Also described herein are security features or patterns printed by the process described herein and security documents comprising one or more of said security features or patterns. The term “security document” refers to a document having a value such as to render it potentially liable to attempts at counterfeiting or illegal reproduction and which is usually protected against counterfeit or fraud by at least one security feature. Examples of security documents include without limitation value documents and value commercial goods. Typical example of value documents include without limitation banknotes, deeds, tickets, checks, vouchers, fiscal stamps and tax labels, agreements and the like, identity documents such as passports, identity cards, visas, bank cards, credit cards, transactions cards, access documents, security badges, entrance tickets, transportation tickets, security threads and the like. The term “value commercial good” refers to packaging material, in particular for pharmaceutical, cosmetics, electronics or food industry that may comprise one or more security features in order to warrant that the content of the packaging is genuine, like for instance genuine drugs. Example of these packaging material include without limitation labels such as authentication brand labels, tax banderoles, tamper evidence labels and seals.

According to one embodiment of the present invention, the security document described herein may further comprise one or more additional layers or coatings either below or on top of the security feature or pattern described herein. Should the adhesion between the substrate and the security feature or pattern described herein be insufficient, for example, due to the substrate material, a surface unevenness or a surface inhomogeneity, an additional layer, coating or a primer between the substrate and the security feature or pattern might be applied as known for those skilled in the art. Moreover, and as disclosed in WO 2010/058026 A2, the presence of an additional layer, coating or a primer between the substrate and a security feature or pattern comprising optically variable magnetic or magnetizable pigment particles could also be used to improve the visual aspect of said security elements.

With the aim of increasing the durability through resistance against soiling or chemicals and the cleanliness and thus the circulation lifetime of security documents, one or more protective layers may be applied on top of the security feature or pattern described herein. When present, the one or more protective layers are typically made of protective varnishes which may be transparent or slightly colored or tinted and may be more or less glossy. Protective varnishes may be radiation curable compositions, thermal drying compositions or any combination thereof. Preferably, the one or more protective layers are made of radiation curable, more preferably UV-Vis curable compositions.

Also described herein are uses of the security features or patterns described herein for the protection of a security document against fraud or illegal reproduction.

The invention proposes the use of inks with a viscosity significantly lower than standard intaglio inks to improve the transfer of large particles, in particular platelet shaped pigment particles, during the intaglio printing process described herein. Furthermore, the present invention provides a relatively low cost printing process due the incorporating of the silkscreen technology. This is particular beneficial for banknotes printers who are more and more equipped with rotatory silkscreen presses and already have a strong knowledge of and expertise in this technology for many years. In addition, use of screen cylinders ensures the inking of only the zones of the plate cylinder corresponding to the image area formed by the pores of the screen cylinder that are left open. Thus the amount of intaglio ink transferred to the plate cylinder is more precisely controlled. As a result, the quantity of wasted intaglio ink removed by the wiping process is reduced.

The methods and processes described herein advantageously provide high quality patterns or features, in particular security patterns or security features, by using an intaglio printing process so as to take advantage of this printing technique, including the high thickness of intaglio printed pattern or feature, the recognizable relief effect (i.e. tactile effect) and anti-soiling characteristics. Indeed, the high pressure applied during the intaglio printing process may also serve as a means for sealing the surface of a substrate, e.g. paper, even in the non-intaglio printed areas; thus intaglio printing contributes to preserve a document against soiling.

All of the documents cited hereinabove may be useful to understand the present invention. The respective disclosure of these documents is thus incorporated by reference herein.

1. A process for intaglio printing a feature or pattern comprising the steps of:
i) inking one or more chablon cylinders with one or more inks having a viscosity falling within the range between about 0.1 Pa·s and about 10 Pa·s at 25° C. and at a shear rate of 1000 s⁻¹, preferably between about 0.1 Pa·s and about 5 Pa·s at 25° C. and 1000 s⁻¹, and within the range between about 0.1 Pa·s and about 30 Pa·s at 25° C. and at a shear rate of 100 s⁻¹, preferably between about 0.1 Pa·s and about 20 Pa·s at 25° C. and at a shear rate of 100 s⁻¹, and comprising particles having a size (d50) up to about 90 microns with the use of one or more screen cylinders comprising urging means, the one or more screen cylinders being connected by means of a connecting duct to an intaglio ink reservoir,
ii) transferring the one or more inks from the one or more chablon cylinders to a plate cylinder carrying one or more intaglio engraved plates,
iii) transferring one or more inks ink from the plate cylinder carrying one or more intaglio engraved plates to a substrate, and
iv) hardening or curing the one or more inks.

2. The process according to claim 1, wherein the one or more inks are first transferred from the one or more chablon cylinders to a collecting cylinder prior to be transferred to the plate cylinder carrying the one or more intaglio engraved plates.

3. The process according to claim 1, wherein the one or more chablon cylinders have a planar surface or comprise a plurality of recessed areas.

4. The process according to claim 1, wherein the hardening or curing step iv) is carried out by means of radiation energy and/or air-drying.

5. The process according to claim 1, wherein at least some of the particles are optically variable pigment particles, preferably optically variable pigment particles selected from the group consisting of thin film interference pigments, interference coated pigments, cholesteric liquid crystal pigments and mixtures thereof.

6. The process according to claim 1, wherein at least some of the particles are magnetic or magnetizable pigment particles.

7. The process according to claim 6, wherein the magnetic or magnetizable pigment particles are optically variable magnetic or magnetizable pigment particles selected from the group consisting of magnetic thin-film interference pigments, magnetic cholesteric liquid crystal pigments, interference coated pigments comprising a magnetic material and mixtures thereof.

8. The process according to claim 6 further comprising a step of exposing the one or more inks to a magnetic field hereby orienting the magnetic or magnetizable pigment particles, said step being carried out after the step of transferring to the substrate (step iii)) and before the hardening or curing step (step iv)).

9. A security feature or pattern printed by the process recited in claim 1.

10. A security document comprising one or more security features or patterns recited in claim 9.

11. A use of the security feature or pattern recited in claim 9 for the protection of a security document against fraud or illegal reproduction.

12. A printing assembly comprising:
a) one or more screen cylinders comprising urging means, each screen cylinder being connected by means of a connecting duct to an intaglio ink reservoir,
b) one or more chablon cylinders, and
c) a plate cylinder carrying one or more intaglio engraved plates.

13. The printing assembly of claim 12 further comprising a collecting cylinder, preferably arranged between the one or more chablon cylinders and the one or more intaglio engraved plates.

14. The printing assembly of claim 12, wherein the one or more chablon cylinders have a planar surface or comprise a plurality of recessed areas.

15. A use of the one or more inks recited in claim 1 in combination with a printing assembly for printing a feature or pattern by an intaglio printing process.
